(19) United States
(12) Patent Application Publication
(10) Pub. No.: US 2026/0037128 A1
(43) Pub. Date: Feb. 5, 2026

(54) CONJOINED MEMORY SYSTEMS SUPPORTING DATA STORAGE IN LARGER MEMORY SYSTEM WHEN SMALLER MEMORY SYSTEM IS UNAVAILABLE AND WITH SMALLER MEMORY SYSTEM READ LATENCY, AND RELATED PROCESSOR-BASED SYSTEMS AND METHODS

(71) Applicant: Microsoft Technology Licensing, LLC, Redmond, WA (US)

(72) Inventors: Kegan SCOWEN, Portland, OR (US); Bezan KAPADIA, Hillsboro, OR (US)

(21) Appl. No.: 18/789,107

(22) Filed: Jul. 30, 2024

(51) Int. Cl. G06F 3/06

(52) U.S. Cl. CPC G06F 3/0611; G06F 3/0659; G06F 3/0673

(57) ABSTRACT

Conjoined memory system that includes a larger memory system conjoined with a smaller memory system to support data storage in the larger memory system when the smaller memory system is unavailable, and related methods of performing memory accesses and computer-readable media are also disclosed. The conjoined memory system is configured to selectively direct new, incoming memory write requests for incoming data (e.g., incoming data packets to be stored) through a bypass data path to be written to memory entries in the smaller memory system if available for data storage (e.g., memory entry(ies) are free). Memory access latency and dynamic power expended for such memory accesses is reduced. However, if the smaller memory system is not available for data storage (e.g., memory entries are full), the conjoined memory system can selectively direct new, incoming memory write requests instead to the larger memory system to be stored in memory entries therein.

### FIELD OF THE DISCLOSURE

The technology of the disclosure relates generally to memory structures in a processor-based system configured to store data and to provide read access to data stored therein.

### BACKGROUND

Processor-based systems including memory systems to support read and write operations from a central processing unit (CPU) or other processor. Memory may be used for data storage and as well as to store program code for storing instructions to be executed. Such processor-based systems conventionally employ both cache and non-cache memory, sometimes referred to as “main memory” or “system memory.” For example, a CPU may have access to an on-chip local, private cache memory. Multiple CPUs in a processor-based system may also have access to a shared cache memory. The processor-based system also employs a main or system memory that contains memory storage units (i.e., memory bit cells) over the entire physical address space of the processor-based system. Each of these different types of memories employ memory arrays that include memory bit cells typically organized in a row and column structure for storing data. A memory row that contains a memory bit cell in a respective column is accessed to read data from or write data to memory. The memory bit cells can be provided in different technologies of memory, such as static random access memory (RAM) (SRAM) bit cells, and dynamic RAM (DRAM) bit cells.

It is becoming increasingly important to be able to provide larger density memory arrays in memories in processor-based systems with increased bandwidth (i.e., reduced access latency). For example, system-on-a-chip (SoC) designs are growing larger with each generation due to the increased number of CPU cores, larger internal interconnect networks, and standard interfaces circuits. Thus, these SoC designs may require larger density memories (e.g., register files, SRAM, logic circuits) to provide increased memory storage to enable such scaling of the SoC. Larger density memories may also have increased access latency as compared to smaller density memories, because the overall memory access latency is based on the access time to the memory bit cells located farthest away from the supporting access circuitry. Also, larger density memories have extended length bit lines that are coupled the supporting access circuitry (e.g., read sense circuits) to reach the increased number of memory row circuits of the memory array. Extending the length of bit lines increases capacitance on the bit lines thus increasing memory access latency. The memory is also typically sized larger to handle worst-case peak bandwidth and transaction round trip latencies, yet the SoC most often incurs low-to-mid bandwidth traffic streams that do not require the full memory footprint of the larger-density memory. Thus, larger density memories can increase the dynamic power consumed by the SoC, thus degrading power and performance requirements.

### SUMMARY

Exemplary aspects disclosed herein include a conjoined memory system that includes a larger memory system conjoined with a smaller memory system to support data storage in the larger memory system when the smaller memory system is unavailable. Related methods of performing memory accesses and computer-readable media are also disclosed. The conjoined memory system is provided in a processor-based system (e.g., coupled to a processor or on-chip in a system-on-a-chip (SoC)) to provide memory for data storage and access. For example, the conjoined memory system may be used as a data packet buffer memory for a node circuit in an interconnect bus in a processor-based system, wherein new generated data packets are temporarily stored in the memory system until such time the data packet can be read out by a data routing circuit to be routed on the interconnect bus. It is desired to provide a smaller memory system in the memory system that has a smaller number of memory entries for storage of data than the larger memory system to reduce memory access latencies, dynamic power, and area requirements. However, the smaller memory system may not have sufficient storage area for increased data bandwidth requirements, such as during times of increased internal data traffic patterns when memory accesses occur at a faster transaction rate. However, with the conjoined memory system including both the smaller and larger memory systems, the conjoined memory system can be configured to selectively direct new, incoming memory write requests for incoming write data (e.g., incoming data packets to be stored) through a bypass data path to be written to memory entries in the smaller memory system if available for data storage (e.g., memory entry(ies) are free). In this manner, memory access latency and dynamic power expended for such memory accesses is reduced through accesses to the smaller memory system. However, if the smaller memory system is not available for data storage (e.g., memory entries are full-not free), the conjoined memory system can selectively direct new; incoming memory write requests instead to the larger memory system to be stored in memory entries in the larger memory system as excess memory storage capacity.

In this manner, the conjoined memory system provides the reduced access latency and dynamic power consumption of a smaller memory system, but still supports a larger memory system when increased data storage is required. The conjoined memory system allows the smaller memory system therein to be sized with a smaller number of memory entries than if a single memory system were provided, because a single memory system would need to be sized with a number of memory entries sufficient for worst-case data bandwidth requirements even though often times, a condition in the processor-based system requiring worst-case data bandwidth requirements is not present.

In another exemplary aspect, the conjoined memory system is designed with data paths such that all incoming data that was previously stored in the conjoined memory system is accessed as outgoing data through memory read requests (e.g., outgoing data packets) to the smaller memory system. In this regard, the conjoined memory system is designed such that even if the larger memory system is selected for new, incoming memory write requests, the data stored in the larger memory system is continuously written to the smaller data memory as memory entries in the smaller data memory become available (i.e. free). This guarantees that the data is available to be read out of the smaller memory system of the conjoined memory system for all outgoing data accesses regardless of how the conjoined memory system selectively, internally directed new memory write requests to be stored in either the smaller memory system or larger memory systems. Also, if outgoing data from the conjoined memory system is always accessed through the smaller memory system, the memory read request latency will always be governed by the access latency to the smaller memory system and “mask” the access latency of the larger memory system.

In another exemplary aspect, once the conjoined memory system determines that new; incoming memory write requests are to be directed to be stored in the larger memory system due to the smaller memory system being unavailable for data storage, the conjoined memory system can be configured to optionally continue to write new, incoming memory write requests to the larger memory system until the memory entries in the larger memory system are empty. In other words, the conjoined memory system will continue to write new; incoming memory write requests to the larger memory system until all new, incoming memory write requests stored in memory entries in the larger memory system has been forwarded to the smaller memory system to be stored therein as memory entries in the smaller memory system become available. This may be useful if it is desired to enforce stored ordering the incoming data as it was received in conjoined memory system and thus accessed as outgoing data (e.g., first in, first out (FIFO)), since with this option, it is guaranteed that the age of any stored incoming data in the larger memory system is younger than the age of any stored incoming data in the smaller memory system.

In this regard, in one exemplary aspect, a memory system is provided. The memory system comprises a smaller memory system comprising a plurality of first memory entries each configured to store data. The memory system also comprises a larger memory system comparing a plurality of second memory entries each configured to store data, and wherein the number of the plurality of second memory entries is larger than the number of the plurality of first memory entries. The memory system is configured to, in response to receipt of a first memory write request comprising first write data on a memory write input determine if none of the plurality of first memory entries in the smaller memory system are available for data storage; and in response to determining none of the plurality of first memory entries are available for data storage; forward the first memory write request to the larger memory system. The larger memory system is configured to: in response to receipt of a forwarded memory write request, write the write data from the forwarded memory write request to a second memory entry of the plurality of second memory entries; and forward first read data stored in a next second memory entry of the plurality of second memory entries to the smaller memory system. The smaller memory system configured to, in response to receipt of the first read data, write the first read data to a first memory entry of the plurality of first memory entries. The memory system is further configured to: receive a next memory read request; and in response to the received next memory read request; assert second read data stored in a next first memory entry of the plurality of first memory entries in the smaller memory system onto a memory read output.

In another exemplary aspect, a method of performing data accesses to a memory system comprising a smaller memory system comprising a plurality of first memory entries each configured to store data, and a larger memory system comparing a plurality of second memory entries each configured to store data, and wherein the number of the plurality of second memory entries is larger than the number of the plurality of first memory entries. The method comprises receiving a first memory write request comprising first write data on a memory write input. The method also comprises determining if none of the plurality of first memory entries in the smaller memory system are available for data storage, in response to receiving the first memory write request. The method also comprises forwarding the first memory write request to the larger memory system, in response to determining none of the plurality of first memory entries in the smaller memory system are available for data storage. The method also comprises writing, in a second memory entry of the plurality of second memory entries in the larger memory system, the first write data from the forwarded memory write request, in response to receipt of the forwarded memory write request to the larger memory system. The method also comprises forwarding first read data stored in a next second memory entry of the plurality of second memory entries in the larger memory system, to the smaller memory system. The method also comprises writing, in a first memory entry of the plurality of first memory entries in the smaller memory system, the first read data, in response to receipt of the first read data. The method also comprises receiving a next memory read request. The method also comprises asserting second read data stored in a next first memory entry of the plurality of first memory entries in the smaller memory system onto a memory read output, in response to the received next memory read request.

In another exemplary aspect, a non-transitory computer-readable medium having stored thereon computer executable instructions is provided. The non-transitory computer-readable medium which, when executed by a processor, causes the processor to access a memory system comprising a smaller memory system comprising a plurality of first memory entries each configured to store data, and a larger memory system comparing a plurality of second memory entries each configured to store data, and wherein the number of the plurality of second memory entries is larger than the number of the plurality of first memory entries, by causing the processor to: receive a first memory write request comprising first write data on a memory write input; determine if none of the plurality of first memory entries in the smaller memory system are available for data storage, in response to receiving the first memory write request; forward the first memory write request to the larger memory system, in response to determining none of the plurality of first memory entries in the smaller memory system are available for data storage; write, in a second memory entry of the plurality of second memory entries in the larger memory system, the first write data from the forwarded memory write request, in response to receipt of the forwarded memory write request to the larger memory system; forward first read data stored in a next second memory entry of the plurality second memory entries in the larger memory system, to the smaller memory system; write, in a first memory entry of the plurality of first memory entries in the smaller memory system, the first read data, in response to receipt of the first read data; receive a next memory read request; and assert second read data stored in a next first memory entry of the plurality of first memory entries in the smaller memory system onto a memory read output, in response to the received next memory read request.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of an exemplary processor-based system that includes an exemplary conjoined memory system that includes both smaller and larger memory systems, wherein the conjoined memory system can be configured to selectively direct new, incoming memory write requests for incoming data to be written to the smaller memory system if available for data storage, and selectively direct new, incoming memory write requests instead to the larger memory system to be stored in memory entries therein if the smaller memory system if not available for data storage, while providing a read access latency of the smaller memory system;

FIG. 2 is a block diagram of an exemplary interconnect bus that can be provided in the processor-based system in FIG. 1, wherein node circuits of the interconnect bus include a conjoined memory system;

FIG. 3 is a block diagram of an exemplary conjoined memory system that can be provided as the conjoined memory system in FIG. 1, wherein the conjoined memory system includes both smaller and larger memory systems, wherein the conjoined memory system can be configured to selectively direct new, incoming memory write requests for incoming data to be written to the smaller memory system if available for data storage, and selectively direct new, incoming memory write requests instead to the larger memory system to be stored in memory entries therein if the smaller memory system if not available for data storage, while providing a read access latency of the smaller memory system;

FIG. 4 is a flowchart illustrating an exemplary memory access process of the conjoined memory system in FIG. 3 selectively direct new, incoming memory write requests for incoming data to be written to the smaller memory system if available for data storage, selectively direct new, incoming memory write requests instead to the larger memory system to be stored in memory entries therein if the smaller memory system if not available for data storage, and supporting outgoing memory read requests through the smaller memory system to provide a read access latency of the smaller memory system;

FIG. 5 is a flowchart illustrating another exemplary memory access process of the conjoined memory system in FIG. 3;

FIG. 6A is a signal diagram illustrating a low bandwidth memory transaction example in the conjoined memory system in FIG. 3, where the incoming rate of memory write requests is low enough to not need to direct the incoming memory write requests to the larger memory system;

FIG. 6B is a signal diagram illustrating a high bandwidth memory transaction example in the conjoined memory system in FIG. 3, where the incoming rate of memory write requests is high enough to need to direct the incoming memory write requests to the larger memory system after the smaller memory system is full;

FIG. 6C is a signal diagram illustrating a medium bandwidth memory transaction example in the conjoined memory system in FIG. 3, where the incoming rate of memory write requests is large enough to need to direct some incoming memory write requests to the larger memory system after the smaller memory system is full; and

FIG. 7 is a block diagram of an exemplary processor-based system that includes a processor and one or more conjoined memory systems including but not limited to the conjoined memory systems in FIGS. 1-3, wherein the one or more conjoined memory systems includes both smaller and larger memory systems, wherein the conjoined memory system can be configured to selectively direct new, incoming memory write requests for incoming data to be written to the smaller memory system if available for data storage, and selectively direct new; incoming memory write requests instead to the larger memory system to be stored in memory entries therein if the smaller memory system if not available for data storage, while providing a read access latency of the smaller memory system.

### DETAILED DESCRIPTION

Exemplary aspects disclosed herein include a conjoined memory system that includes a larger memory system conjoined with a smaller memory system to support data storage in the larger memory system when the smaller memory system is unavailable. Related methods of performing memory accesses and computer-readable media are also disclosed. The conjoined memory system is provided in a processor-based system (e.g., coupled to a processor or on-chip in a system-on-a-chip (SoC)) to provide memory for data storage and access. For example, the conjoined memory system may be used as a data packet buffer memory for a node circuit in an interconnect bus in a processor-based system, wherein new generated data packets are temporarily stored in the memory system until such time the data packet can be read out by a data routing circuit to be routed on the interconnect bus. It is desired to provide a smaller memory system in the memory system that has a smaller number of memory entries for storage of data than the larger memory system to reduce memory access latencies, dynamic power, and area requirements. However, the smaller memory system may not have sufficient storage area for increased data bandwidth requirements, such as during times of increased internal data traffic patterns when memory accesses occur at a faster transaction rate. However, with the conjoined memory system including both the smaller and larger memory systems, the conjoined memory system can be configured to selectively direct new, incoming memory write requests for incoming write data (e.g., incoming data packets to be stored) through a bypass data path to be written to memory entries in the smaller memory system if available for data storage (e.g., memory entry(ies) are free). In this manner, access latency and dynamic power expended for such memory accesses is reduced through accesses to the smaller memory system. However, if the smaller memory system is not available for data storage (e.g., memory entries are full-not free), the conjoined memory system can selectively direct new; incoming memory write requests instead to the larger memory system to be stored in memory entries in the larger memory system as excess memory storage capacity.

In this manner, the conjoined memory system provides the reduced access latency and dynamic power consumption of a smaller memory system, but still supports a larger memory system when increased data storage is required. The conjoined memory system allows the smaller memory system therein to be sized with a smaller number of memory entries than if a single memory system were provided, because a single memory system would need to be sized with a number of memory entries sufficient for worst-case data bandwidth requirements even though often times, a condition in the processor-based system requiring worst-case data bandwidth requirements is not present.

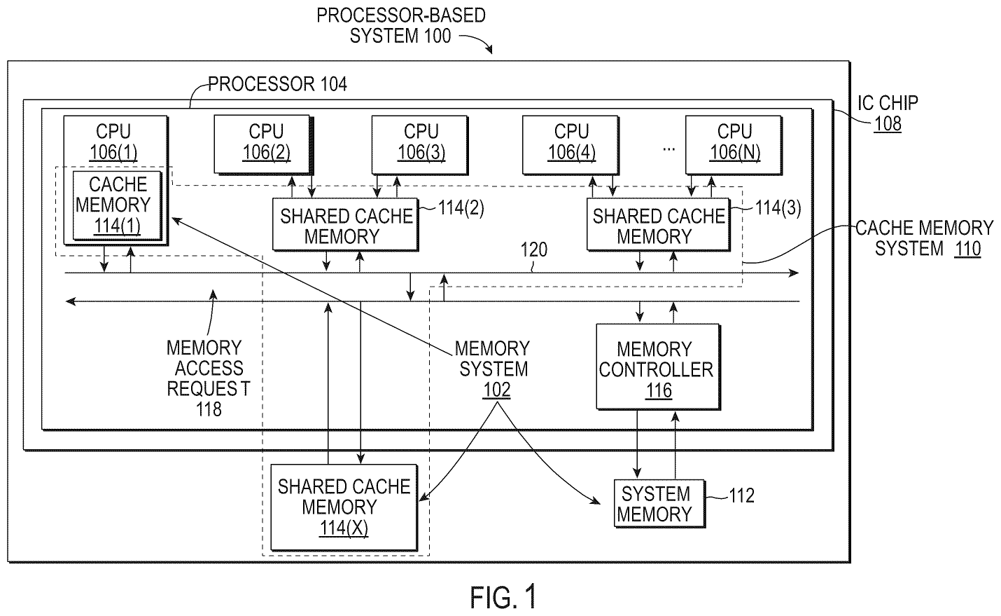

In this regard, FIG. 1 is a block diagram of an exemplary processor-based system 100. As discussed in more detail below, the processor-based system 100 can include one or more conjoined memory systems that include a smaller memory system and a larger memory system configured to store write data for incoming memory write requests in the event that the smaller memory system does not have memory entries available for storage, but provides a read access latency of the smaller memory system. The processor-based system 100 includes a memory system 102 that includes memories any of which can include a conjoined memory system. The processor-based system 100 includes a processor 104 and the memory system 102. The processor 104 includes one or more respective central processing units (CPUs) 106(1)-106(N), wherein ‘N’ is a positive whole number representing the number of CPUs included in the processor 104. The processor 104 can be packaged in an integrated circuit (IC) chip 108.

The CPUs 106(1)-106(N) in the processor 104 are configured to issue memory write requests (i.e., memory read/write access requests) to the memory system 102. The memory system 102 in this example includes a cache memory system 110 and a system memory 112. The system memory 112 is a memory that is fully addressable by the physical address (PA) space of the processor-based system 100. The cache memory system 110 in the memory system 102 includes one or more cache memories 114(1)-114(X), where ‘X’ is a positive whole number representing the number of cache memories included in the processor 104. The cache memories 114(2)-114(X) (e.g., random access memory (RAM) cache memories) may be at different hierarchies in the processor-based system 100 and that are logically located between the CPUs 106(1)-106(N) and the system memory 112 (e.g., a system RAM). A memory controller 116 controls access to the system memory 112. Using CPU 106(1) as an example, if a memory access request 118 as a memory write request issued by the CPU 106(1) is not in a private cache memory 114(1) (i.e., a cache miss to cache memory 114(1)) which may be considered a level one (L1) cache memory, the private cache memory 114(1) forwards the memory access request 118 over an interconnect bus 120 in this example to a shared cache memory 114(X) shared with all of the CPUs 106(1)-106(N), which may be a level 3 (L3) cache memory. The requested data in the memory access request 118 is eventually either fulfilled in a cache memory 114(1)-114(X) or the system memory 112 if not contained in any of the cache memories 114(1)-114(X).

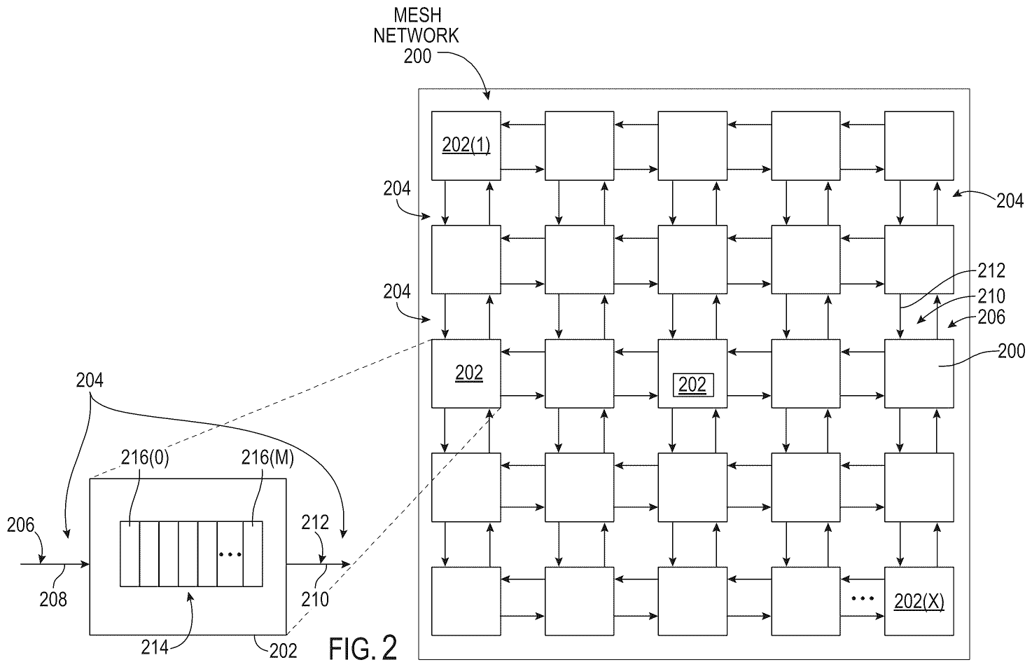

The interconnect bus 120 in the processor-based system 100 in FIG. 1 can also be configured to allow any of the CPUs 106(1)-106(N) to request access to other shared devices or peripherals that may be coupled to the interconnect bus 120 or otherwise accessible through communications on the interconnect bus 120. As another example, the interconnect bus 120 can be configured to form a mesh network to communicatively couple a plurality of node circuits to each other, including the CPUs 106(1)-106(N) and the memories of the memory system 102. For example, FIG. 2 is a block diagram of an exemplary interconnect bus 120 that can be provided as the interconnect bus 120 in the processor-based system 100 in FIG. 1. As shown therein, the interconnect bus 120 forms a mesh network 200 wherein node circuits 202(1)-202(X) are coupled to each other by segments 204 of the mesh network 200. The node circuits 202(1)-202(X) are configured to transmit and receive data so that the data is routed to different node circuits 202 among the node circuits 202(1)-202(X) in the mesh network 200. Data is then transmitted and received between the node circuits 202 among the node circuits 202(1)-202(X) and system components (e.g., on the same IC chip 108 in the memory system 102 in FIG. 1). In some aspects, the node circuits 202(1)-202(X) are routers that are configured to route data between the node circuits 202 and thus allow for the routing between different system components that are coupled to the node circuits 202(1)-202(X). Data transfers are generally synchronized by a system clock where the system clock is employed to clock sequential circuits in the mesh network 200.

In one example, the node circuits 202(1)-202(X) are each configured to perform specified functions (e.g., either through hardware circuits along or a combination of hardware circuits executing computer instructions) on input data 206 received on an input 208 and thereby generate output data 210 on an output 212 as part of transferring data and/or requests for data in the mesh network 200. For example, if the mesh network 200 in FIG. 2 is employed as the interconnect bus 120 in the processor-based system 100 in FIG. 1, the memory access request 118 issued by a CPU 106(1)-106(N) may be transferred through certain node circuits 202(1)-202(X) to become the input data 206 for another node circuit 202(1)-202(X), which implements computer executable instructions for its input data 206. In order for processing of data to progress effectively in the mesh network 200, data should be transferred through the node circuits 202(1)-202(X) without delay. Unfortunately, data transfers between the node circuits 202(1)-202(X) are sometimes slowed down or even stopped resulting in data traffic congestion in the mesh network 200 formed by the node circuits 202(1)-202(X). This data traffic congestion can sometimes prevent a transferring node circuit 202(1)-202(X) from transferring output data 210 as input data 206 to a receiving node circuit 202(1)-202(X) until data in the receiving node circuit 202(1)-202(X) is transferred to another receiving node circuit 202(1)-202(X). The interdependency between data transfers of the node circuits 202(1)-202(X) can sometimes prevent data transfers from moving forward and thereby result in data transfer failures or other bottlenecks.

In this regard, as shown in FIG. 2, to provide for the mesh network 200 to be able to handle various bandwidth and bottleneck data transfer scenarios, each node circuits 202(1)-202(X) includes a buffer memory 214 that has a plurality of memory entries 216(0)-216 (M) configured to store received input data 206 on its input 208 before such input data 206 is transferred as output data 210 on its output 212 (e.g., in a first in, first-out (FIFO) order). In this manner, if the data rate of the input data 206 is faster than a given node circuit 202 can route such input data 206 as output data 210 to another next receiving node circuit 202(1)-202(X), the node circuit 202 is capable of temporarily retaining the input data 206 until it can be transferred. In this manner, if the buffer memory 214 has available/free memory entries 216(0)-216(M) for storage of new input data 206, a receiving node circuit 202(1)-202(X) will not have to reject input data 206 received from a transferring node circuit 202(1)-202(X) until such time the input data 206 can be output as output data 210 by the receiving node circuit 202(1)-202(X). Note that although only one input 208 and one output 212 are shown in a node circuit 202, a node circuit 202 in this example will have multiple inputs 208 and multiple outputs 212 so that each node circuit 202(1)-202(X) can be coupled to a plurality of other node circuits 202(1)-202(X) as part of the mesh network 200.

Note that the data traffic patterns in the mesh network 200 could vary dramatically over time depending on the bandwidth of memory write requests in a processor-based system employing the mesh network 200, such as the processor-based system 100 in FIG. 1. For instance, a node circuit 202(1)-202(X) in the mesh network 200 could receive input data 206 at a rate of 10 megabytes (MB) per second(s) during a sustained burst, but then suddenly thereafter only receive sporadic input data 206 at a lower bandwidth on the order of two MB/s. Thus, if the buffer memory 214 in the node circuits 202(1)-202(X) are sized with memory entries for a worst-case scenario in this example, the buffer memory 214 would have to be sized to handle receiving and storing input data 206 at a rate of 10 MB/s based on the worst-case lower bandwidth possible for transferring out the input data 206 as output data 210 to another receiving node circuit 202(1)-202(X). However, sizing the buffer memory 214 for a worst-case bandwidth in the mesh network 200 increases access latency over a smaller density buffer memory. Larger density memories have increased access latency as compared to smaller density memories, because the overall access latency is based on the access time to the memory bit cells located farthest away from the supporting access circuitry. Also, larger memory density can have extended length bit lines that are coupled to the supporting access circuitry (e.g., read sense circuits) to reach the increased number of memory row circuits of the memory array. Extending the length of bit lines increases capacitance on the bit lines thus increasing access latency. Increased memory access latencies also lead to increased dynamic power consumption.

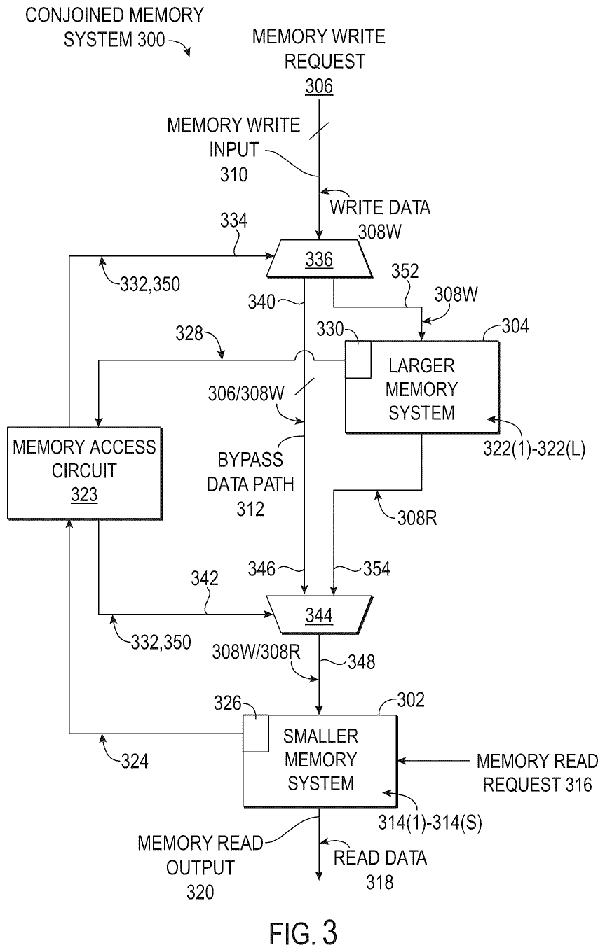

In this regard, FIG. 3 illustrates an exemplary conjoined memory system 300 that includes both a smaller memory system 302 and a larger memory system 304. As discussed in more detail below, the inclusion of the smaller memory system 302 and the larger memory system 304 in the conjoined memory system 300 allows stored data to be accessed through memory read requests at the lower memory access latency of the smaller memory system 302, but to also provides the larger storage capability of the larger memory system 304 if needed, such as during high bandwidth input data scenarios. For example, the conjoined memory system 300 can be provided as the buffer memory 214 in any of the node circuits 202(1)-202(X) in the mesh network 200 in FIG. 2 and/or in any of the memories in the memory system 102 in the processor-based system 100 in FIG. 1. As discussed in more detail below, the conjoined memory system 300 can be configured to selectively direct new, incoming memory write requests 306 containing write data 308W (e.g., incoming data packets to be stored) received on a memory write input 310, through a bypass data path 312 to be written to first memory entries 314(1)-314(S) in the smaller memory system 302 if available for data storage (e.g., memory entry(ies) 314(1)-314(S) are free). First memory entries 314(1)-314(S) are available in the smaller memory system 302 if they either have not been yet written to, or they have been written to but then such data is subsequently read out (i.e. popped) from the smaller memory system 302 through a received memory read request 316 as read data 318 on a memory read output 320.

However, if the smaller memory system 302 is not available for data storage (e.g., its memory entries 314(1)-314(S) are all full-not free), the conjoined memory system 300 can selectively direct the new, incoming memory write requests 306 instead to the larger memory system 304 to be stored in second memory entries 322(1)-322(L) in the larger memory system 304 as excess memory storage capacity. The number of second memory entries 322(1)-322(L) in the larger memory system 304 is greater than the number of first memory entries 314(1)-314(S) in the smaller memory system 302. As discussed in more detail below, write data 308W that is stored in the larger memory system 304 is also forwarded as read data 308R to the smaller memory system 302 to be stored in first memory entries 314(1)-314(S) therein as they become available to store new write data 308W from incoming memory write requests 306 as the read data 308R from the larger memory system 304. Thus, memory read request 316 issued to the conjoined memory system 300 are to the smaller memory system 302 since the smaller memory system 302 will always eventually store the incoming write data 308W from the incoming memory write requests 306 either directly from the bypass data path 312 or as read data 308R from the larger memory system 304. In this manner, the conjoined memory system 300 will have the read access latency of the smaller memory system 302. Also, when the bandwidth of the incoming memory write requests 306 is such that the larger memory system 304 is not required to store the write data 308W for the incoming memory write requests 306 (i.e., read data 318 is retrieved from the first memory entries 314(1)-314(S) in response to memory read requests 316 before the first memory entries 314(1)-314(S) fill up), the dynamic power expended by storing the write data 308W and then asserting the stored write data 308W as read data 318 on the memory read output 320 is based on the smaller size of the smaller memory system 302.

In this manner, the conjoined memory system 300 in FIG. 3 provides the reduced access latency and dynamic power consumption of the smaller memory system 302, but still supports the larger memory system 304 when increased data storage is required. The conjoined memory system 300 allows the smaller memory system 302 therein to be sized with a smaller number of memory entries 314(1)-314(S) than if a single memory system were provided, because a single memory system would need to be sized with a number of memory entries sufficient for worst-case data bandwidth requirements even though often times, a condition in a processor-based system requiring worst-case data bandwidth requirements is not present.

Note that the smaller memory system 302 and the larger memory system 304 can be any type of memory system and include any type of memory. For example, the smaller memory system 302 and the larger memory system 304 may each include an internal memory controller that controls write and read access to their respective memory entries 314(1)-314(S), 322(1)-322(L) each as part of a respective memory array. The memory entries 314(1)-314(S), 322(1)-322(L) can be provided as a RAM (e.g., a static RAM (SRAM)) where each memory entry 314(1)-314(S), 322(1)-322(L) can be randomly access based on a memory address. For example, the conjoined memory system 300 can be configured as a RAM configured to receive memory write requests 306 and memory read requests 316 that include memory addresses to address a specific memory entry 314(1)-314(S), 322(1)-322(L). As another example, the conjoined memory system 300 may be configured as a buffer memory where memory addresses are not required, because the smaller memory system 302 and larger memory system 304 are not randomly accessed. The memory entries 314(1)-314(S), 322(1)-322(L) in the respective the smaller memory system 302 and the larger memory system 304 can be configured to be accessed in a specific order, such as through sequential locations. For example, the conjoined memory system 300 can be configured as a FIFO buffer, where memory entries 314(1)-314(S), 322(1)-322(L) are written to in sequential locations and then read out in the order written. In this regard, memory entries 314(1)-314(S), 322(1)-322(L) in the respective the smaller memory system 302 and the larger memory system 304 could also be provided as a flop memory that includes a flip-flop for each respective memory entry 314(1)-314(S), 322(1)-322(L) that are serialized coupled to each other in their respective smaller and larger memory systems 302, 304. Other buffer structures are also possible to be supported by the conjoined memory system 300, including last-in, first-out (LIFO).

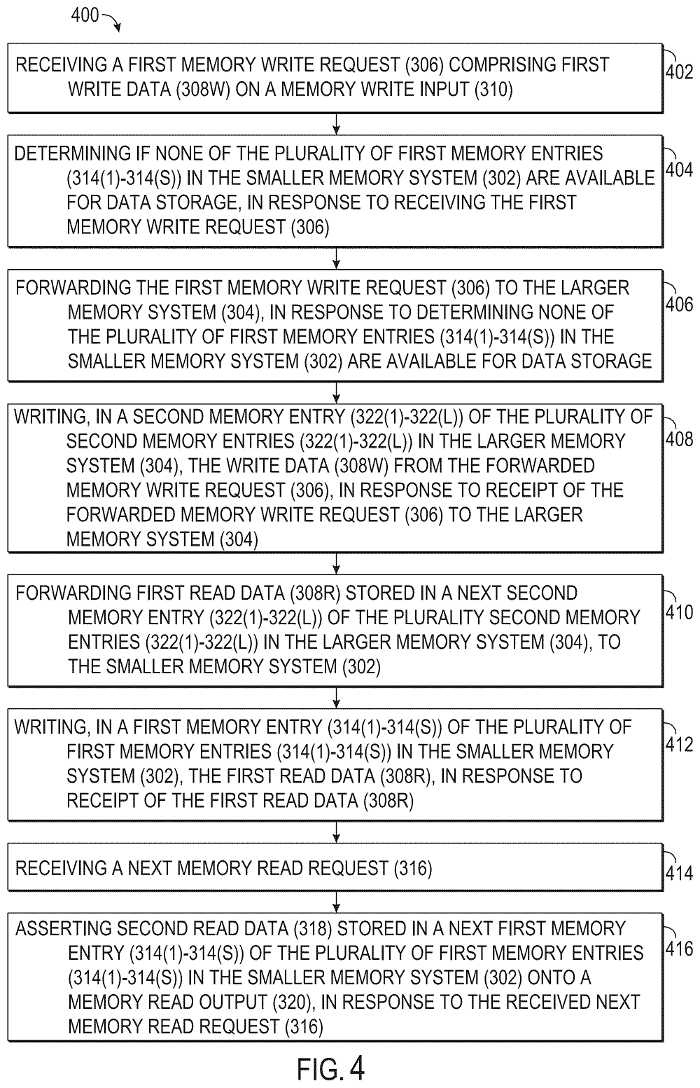

FIG. 4 is a flowchart illustrating an exemplary memory access process 400 for the conjoined memory system 300 in FIG. 3 as an example. In this regard, as shown in the process 400 in FIG. 4 referencing the conjoined memory system 300 in FIG. 3, a first step can be receiving a first memory write request 306 comprising first write data 308W on a memory write input 310 (block 402 in FIG. 4). A next step in the process 400 can be determining if none of the plurality of first memory entries 314(1)-314(S) in the smaller memory system 302 are available for data storage, in response to receiving the first memory write request 306 (block 404 in FIG. 4). In the example, the conjoined memory system 300 in FIG. 3 includes a memory access circuit 323 that is coupled to the smaller memory system 302 and the larger memory system 304. The memory access circuit 323 is configured to receive a smaller memory tracker indicator 324 from a smaller memory tracker circuit 326 that is configured to track the availability of its first memory entries 314(1)-314(S) for storing new first write data 308W, or at least determine if one of the first memory entries 314(1)-314(S) in the smaller memory system 302 is available. In this example, the memory access circuit 323 is configured to use the received smaller memory tracker indicator 324 to determine if none of the plurality of first memory entries 314(1)-314(S) in the smaller memory system 302 are available for data storage, meaning the smaller memory system 302 is full and cannot yet store new first write data 308W (block 404 in FIG. 4).

With continuing reference to FIG. 4, in response to the memory access circuit 323 determining none of the plurality of first memory entries 314(1)-314(S) in the smaller memory system 302 are available for data storage (block 404 in FIG. 4), the memory access circuit 323 is configured to cause the first memory write request 306 to be forwarded to the larger memory system 304 for its first write data 308W to be stored therein (block 406 in FIG. 4). The memory access circuit 323 could be configured to first determine through a larger memory tracker indicator 328 from a larger memory tracker circuit 330 if a second memory entry 322(1)-322(L) in the larger memory system 304 is first available before forwarding the first memory write request 306 to the larger memory system 304 to store the first write data 308W. The larger memory tracker circuit 330 is configured to track the availability of the second memory entries 322(1)-322(L) in the larger memory system 304, or at least determine if one of the second memory entries 322(1)-322(L) in the larger memory system 304 is available. If a second memory entry 322(1)-322(L) in the larger memory system 304 is not available in this scenario, the memory access circuit 323 can be configured to delay the forwarding of the first memory write request 306 until a second memory entry 322(1)-322(L) in the larger memory system 304 becomes available.

In this manner, the larger memory system 304 is available to store the first write data 308W from new incoming memory write requests 306 if there is not sufficient storage available in the smaller memory system 302. The larger memory system 304 is then configured to write the received first write data 308W in a second memory entry 322(1)-322(L) in response to receiving the forwarded memory write request 306 (block 408 in FIG. 4). To provide that the smaller memory system 302 is the memory accessed to obtain read data 318 based on previous received first write data 308W in response to received memory read requests 316, the larger memory system 304 also forwards the stored first write data 308W stored in a next second memory entry 322(1)-322(L) in the larger memory system 304, as first read data 308R to the smaller memory system 302 as a memory entry 314(1)-314(S) in the smaller memory system 302 becomes available (block 410 in FIG. 4). In response, the smaller memory system 302 writes the received first read data 308R forwarded by the larger memory system 304 into an available first memory entry 314(1)-314(S) in the smaller memory system 302 (block 412 in FIG. 4).

Then, as further shown in FIG. 4, the smaller memory system 302 is configured to receive a next memory read requests 316 to retrieve stored data in the conjoined memory system 300 (block 414 in FIG. 4). As previously discussed, this design provides that all memory read requests 316 are directed to the smaller memory system 302 so as to provide for the read access latency of the conjoined memory system 300 to be that of the smaller memory system 302. In this regard, in response to a received memory read request 316 (block 414 in FIG. 4), the smaller memory system 302 asserts second read data 318 stored in a next first memory entry 314(1)-314(S) in the smaller memory system 302 onto the memory read output 320 (block 416 in FIG. 4).

If however, in block 404 in FIG. 4, it was determined that one or more of the first memory entries 314(1)-314(S) in the smaller memory system 302 was available, the memory access circuit 323 can be configured to instead forward the received first memory write request 306 with the first write data 308W on the bypass data path 312 as shown in FIG. 3 to the smaller memory system 302 as opposed to the larger memory system 304. In response to the smaller memory system 302 receiving the first memory write request 306, the smaller memory system 302 is configured to write the first write data 308W in the first memory write request 306 to an available first memory entry 314(1)-314(S) in the smaller memory system 302.

In this manner, according to the process 400 in FIG. 4, the conjoined memory system 300 in FIG. 3 provides the reduced access latency and dynamic power consumption of the smaller memory system 302, but still supports the larger memory system 304 when increased data storage is required. The conjoined memory system 300 allows the smaller memory system 302 therein to be sized with a smaller number of memory entries 314(1)-314(S) than if a single memory system were provided, because a single memory system would need to be sized with a number of memory entries sufficient for worst-case data bandwidth requirements even though often times, a condition in a processor-based system requiring worst-case data bandwidth requirements is not present.

In an example, it is desired for the conjoined memory system 300 in FIG. 3 to continue to forward received new memory write requests 306 to the larger memory system 304 for storage once it is determined that there is not an available first memory entry 314(1)-314(S) in the smaller memory system 302 for storing the write data 308W for the new memory write requests 306. In this example, even if a first memory entry 314(1)-314(S) become available in the smaller memory system 302, write data 308W from new memory write requests 306 is still forwarded to the larger memory system 304 as opposed to being forwarded directly to the smaller memory system 302 on the bypass data path 312. This is because it is desired to maintain the order of received write data 308W in the order of their received memory write requests 306, so that the write data 308W can also be output in order as read data 318 on the memory read output 320) in response to received memory read requests 316. As discussed above, the larger memory system 304 is configured to forward stored write data 308W as read data 308R to the smaller memory system 302, so that as memory read requests 316 are received, all read data 318 is accessed through the smaller memory system 302. By the larger memory system 304 forwarding stored write data 308W as the read data 308R to be stored in the smaller memory system 302, the order of write data 308W can be maintained in the smaller memory system 302. However, in this example, if and when all the write data 308W stored in the larger memory system 304 is forwarded to the smaller memory system 302, and all the second memory entries 322(1)-322(L) in the larger memory system 304 are available, the conjoined memory system 300 can then be configured to forward new received memory write requests 306 on the bypass data path 312 directly to the smaller memory system 302 if there are available first memory entries 314(1)-314(S) in the smaller memory system 302. The order of the write data 308W is maintained in this instance because all the previous stored write data 308W in the larger memory system 304 has been forwarded to the smaller memory system 302 with no remaining write data 308W stored in the larger memory system 304 at that time. In this manner, the write access latency of the smaller memory system 302 is realized when the smaller memory system 302 is again available for write data 308W storage if the order of the write data 308W can be maintained.

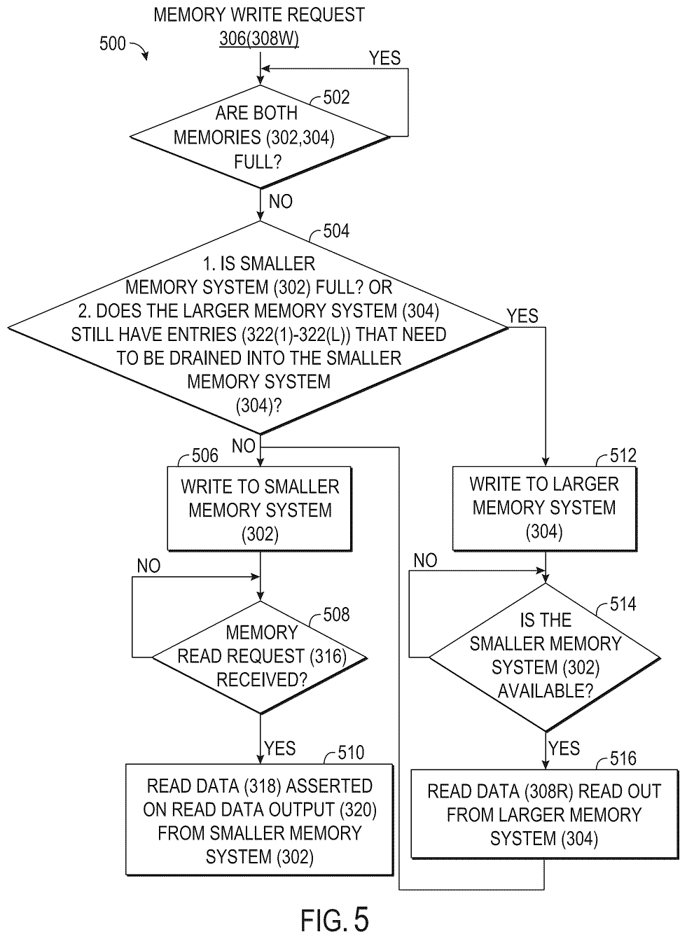

In this regard, FIG. 5 is a flowchart illustrating another exemplary memory access process 500 that can be performed in the conjoined memory system 300 in FIG. 3 that includes additional exemplary functionality of writing write data 308W from received memory write requests 306 to the larger memory system 304 if the smaller memory system 302 does not have availability to store new write data 308W, but then continuing to forward the received memory write requests 306 to the larger memory system 304 until the larger memory system 304 is depleted of stored write data 308W.

In this regard, as shown in FIG. 5, the process 500 involves for each received new memory write request 306 with write data 308W, the memory access circuit 323 in FIG. 3 determining first if both the smaller memory system 302 and the larger memory system 304 are full (i.e., not available to store the write data 308W) (block 502 in FIG. 5). As previously discussed, the memory access circuit 323 can use the smaller memory tracker indicator 324 and larger memory tracker indicator 328 to determine if the respective smaller memory system 302 and the larger memory system 304 are full or not. In other words, are all memory entries 314(1)-314(S), 322(1)-322(L) currently storing valid write data 308W. If so, this means that the new memory write request 306 cannot be forward to either the smaller memory system 302 or the larger memory system 304, and is instead delayed by repeating block 502 until either the smaller memory system 302 or the larger memory system 304 become available (block 502 in FIG. 5).

Once the smaller memory system 302 or the larger memory system 304 are determined to be available by the memory access circuit 323 (block 502 in FIG. 5), the memory access circuit 323 determines if the smaller memory system 302 is full or if the larger memory system 304 has any second memory entries 322(1)-322(L) that are not available, meaning they have valid stored write data 308W that has not be forwarded as read data 308R to the smaller memory system 302 (block 504 in FIG. 5). If both indications are false, this means that the write data 308W from the received memory write request 306 can be stored in the smaller memory system 302. In this instance, as shown in FIG. 3, the memory access circuit 323 issues a smaller memory control signal 332 to a de-multiplexor control input 334 of a de-multiplexor circuit 336 to cause the memory write request 306 on the memory write input 310 coupled to the de-multiplexor input 338 to be coupled to a first de-multiplexor output 340 coupled to the bypass data path 312 (block 506 in FIG. 5). The memory access circuit 323 also asserts the smaller memory control signal 332 on a multiplexor control input 342 of a multiplexor circuit 344 to cause the multiplexor circuit 344 to couple the memory write request 306 on the bypass data path 312 coupled to a first multiplexor input 346 coupled to the bypass data path 312 and first de-multiplexor output 340, to a multiplexor output 348 coupled to the smaller memory system 302 (block 506 in FIG. 5). This causes the smaller memory system 302 to write the received write data 308W coupled to the bypass data path 312 to an available first memory entry 314(1)-314(S). The smaller memory system 302 is ready to receive a memory read request 316 (block 508 in FIG. 5), and in response, assert stored write data 308W as read data 318 on the memory read output 320 (block 510 in FIG. 5).

With continuing reference to FIG. 5, if however in block 504, the memory access circuit 323 determines that either the smaller memory system 302 is full or the larger memory system 304 has a second memory entry 322(1)-322(L) that is not available, meaning the larger memory system 304 has valid stored write data 308W that has not been forwarded as read data 308R to the smaller memory system 302, the memory access circuit 323 is configured to cause the received memory write request 306 to be forwarded to the larger memory system 304 to store the write data 308W. This occurs once either the smaller memory system 302 first becomes full without the larger memory system 304 having any existing valid stored write data 308W, or if the larger memory system 304 was previously controlled to store write data 308W and all previously stored write data 308W in the larger memory system 304 has not been forwarded to the smaller memory system 302. In this scenario, the memory access circuit 323 causes the memory write request 306 to be forwarded to the larger memory system 304 to be written in an available second memory entry 322(1)-322(L) if and when a second memory entry 322(1)-322(L) is available (block 512 in FIG. 5). In this example, the memory access circuit 323 issues a larger memory control signal 350 to the de-multiplexor control input 334 of the de-multiplexor circuit 336 to cause the memory write request 306 on the memory write input 310 coupled to the de-multiplexor input 338 to be coupled to a second de-multiplexor output 352 coupled to the larger memory system 304.

Then, as shown in FIG. 5, the memory access circuit 323 determines if the smaller memory system 302 has an available first memory entry 314(1)-314(S) that can be written with read data 308R as previously stored write data 308W in the larger memory system 304 (block 514 in FIG. 5). This is so that as previously discussed, the larger memory system 304 can move or drain previously stored write data 308W to the smaller memory system 302 to be stored, so that such write data 308W can be accessed through a memory read request 316 to the smaller memory system 302. There are several ways that the memory access circuit 323 can determine if the smaller memory system 302 has an available first memory entry 314(1)-314(S) that can be written with read data 308R. For example, the memory access circuit 323 could track when a memory read request 316 to the smaller memory system 302 has been completed, since in this case, a first memory entry 314(1)-314(S) in the smaller memory system 302 would be available. As another example, the memory access circuit 323 could use the smaller memory tracker indicator 324 to determine when a first memory entry 314(1)-314(S) in the smaller memory system 302 is available. In any scenario, once the memory access circuit 323 determines the smaller memory system 302 has an available first memory entry 314(1)-314(S) that can be written with read data from the larger memory system 304 (block 514 in FIG. 5), the memory access circuit 323 causes the larger memory system 304 to read out write data 308W as read data 308R to be forwarded to the smaller memory system 302 to be stored (block 516 in FIG. 5), which is then written in the smaller memory system 302 by going to block 506 in FIG. 5.

With reference to the example in FIG. 3, in response to the memory access circuit 323 determining that a first memory entry 314(1)-314(S) in the smaller memory system 302 is available to be stored with read data 308R from the larger memory system 304, the memory access circuit 323 issues the larger memory control signal 350 to the multiplexor control input 342 of the multiplexor circuit 344. This causes the multiplexor circuit 344 to pass read data 308R read from the larger memory system 304 and coupled to a second multiplexor input 354, to be coupled to the multiplexor output 348 to be forwarded to the smaller memory system 302 to be stored.

In block 504 in FIG. 5, the memory access circuit 323 will continue to cause new received memory write requests 306 to be forwarded to the larger memory system 304 to be stored until all the write data 308W previously stored in the larger memory system 304 is depleted by being forwarded to the smaller memory system 302 to be stored. Thereafter, the path at block 506 will be taken in the process 500 in FIG. 5 to write data 308W from subsequently received memory write requests 306 until and if the smaller memory system 302 becomes full, such as due to a higher bandwidth of memory write requests 306 that cannot be read out fast enough to prevent the smaller memory system 302 from becoming full. Once the smaller memory system 302 becomes full, the memory access circuit 323 will once again forward subsequently received memory write requests 306 to the larger memory system 304 and continue to do so until all previously stored write data 308W therein is depleted to the smaller memory system 302 (block 514 in FIG. 5). The process 500 can continue and vary back and forth between selecting the smaller memory system 302 and larger memory system 304 for storing new write data 308W from new received memory write requests 306 dependent on the bandwidth requirements of the memory write requests 306.

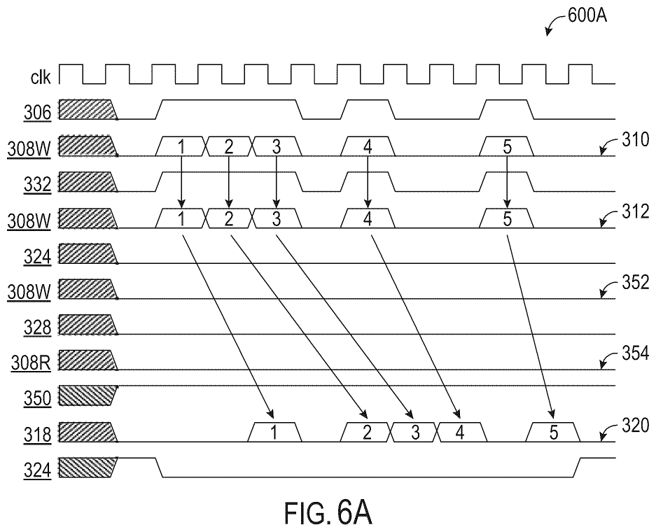

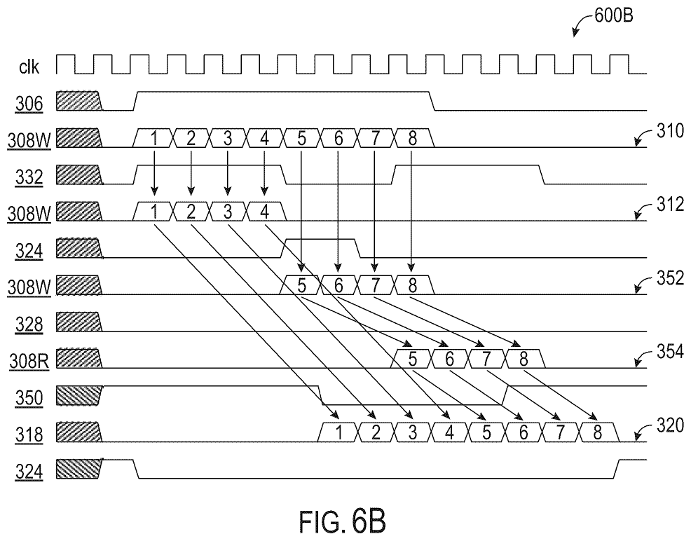

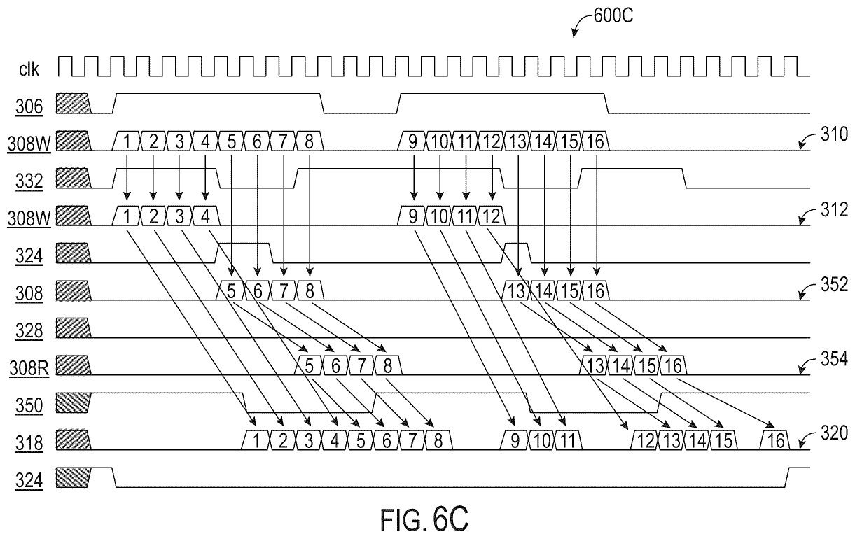

FIG. 6A is a signal diagram 600A illustrating a low bandwidth memory transaction example in the conjoined memory system 300 in FIG. 3, where the incoming rate of memory write requests 306 is low enough to not need to direct the incoming memory write requests 306 to the larger memory system 304. The signals illustrated in FIG. 6A are shown with common element numbers from those previously discussed in FIG. 3. In this example, assume that the smaller memory system 302 has four (4) first memory entries 314(1)-314(S). As shown in FIG. 6A, in this example, write data 308W for five (5) memory write requests 306 are received as [1, 2, 3, 4, 5]. The smaller memory control signal 332 is enabled by the memory access circuit 323 to cause the memory write requests 306 to be stored in the smaller memory system 302. Because the write data 308W is began to be read out as read data 318 before the fifth memory write request 306 [5] is received, the smaller memory system 302 is never full. Thus, the memory access circuit 323 can continue to issue the smaller memory control signal 332 to cause the memory write requests 306, including the fifth memory write request 306 [5] to be forwarded directly on the bypass data path 312 to the smaller memory system 302 to be stored.

FIG. 6B is a signal diagram 600B illustrating a high bandwidth memory transaction example in the conjoined memory system 300 in FIG. 3, where the incoming rate of memory write requests 306 is high enough to need to direct the incoming memory write requests 306 to the larger memory system 304. The signals illustrated in FIG. 6B are shown with common element numbers from those previously discussed in FIG. 3. In this example, again assume that the smaller memory system 302 has four (4) first memory entries 314(1)-314(S). As shown in FIG. 6B, in this example, write data 308W for eight (8) memory write requests 306 are received as [1, 2, 3, 4, 5, 6, 7, 8]. The smaller memory control signal 332 is enabled by the memory access circuit 323 to cause the first four (4) memory write requests 306 [1, 2, 3, 4] to be stored in the smaller memory system 302. Because the write data 308W has not begun to be read out as read data 318 before the fifth memory write request 306 [5] is received, the smaller memory system 302 becomes full. Thus, the memory access circuit 323 does not continue to issue the smaller memory control signal 332 to cause the fifth memory write request 306 [5] to be forwarded directly on the bypass data path 312 to the smaller memory system 302 to be stored. The memory access circuit 323 asserts the larger memory control signal 350 to cause the memory write requests 306 [5, 6, 7, 8] to be forwarded on the second de-multiplexor output 352 to the larger memory system 304 to be stored. Eventually, as shown in FIG. 6B, memory read requests 316 are received that read out write data 308W for memory write requests 306 [1-8] as read data 318. Thus, as each write data 308W is read out from a memory read request 316 as read data 318, a memory entry 314(1)-314(S) of the smaller memory system 302 becomes available. In response, the memory access circuit 323 asserts the larger memory control signal 350 to cause the multiplexor circuit 344 to forward stored write data 308W in the larger memory system 304 as read data 308R for the memory write requests 306 [5, 6, 7, 8] to be stored in the smaller memory system 302. As shown in FIG. 6B, the read data 308R for each of the memory write requests 306 [1-8] can be read out sequentially for each clock signal (clk) such that the read latency is the read access latency of the smaller memory system 302.

FIG. 6C is a signal diagram 600C illustrating a medium bandwidth memory transaction example in the conjoined memory system 300 in FIG. 3, where the incoming rate of memory write requests 306 is high enough to need to direct the incoming memory write requests 306 to the larger memory system 304, but the larger memory system 304 does become depleted where new memory write requests 306 can again be stored in the smaller memory system 302. The signals illustrated in FIG. 6C are shown with common element numbers from those previously discussed in FIG. 3. In this example, again assume that the smaller memory system 302 has four (4) first memory entries 314(1)-314(S). As shown in FIG. 6C, in this example, write data 308W for two eight (8) memory write requests 306 are received as [1-8] and [9-16]. However, there is a time gap between the two bursts of eight (8) memory write requests 306. The smaller memory control signal 332 is enabled by the memory access circuit 323 to cause the first four (4) memory write requests 306 [1, 2, 3, 4] to be stored in the smaller memory system 302. Because the write data 308W has not begun to be read out as read data 318 before the fifth memory write request 306 [5] is received, the smaller memory system 302 becomes full. Thus, the memory access circuit 323 does not continue to issue the smaller memory control signal 332 to cause the fifth memory write request 306 [5] to be forwarded directly on the bypass data path 312 to the smaller memory system 302 to be stored. The memory access circuit 323 asserts the larger memory control signal 350 to cause the memory write requests 306 [5, 6, 7, 8] to be forwarded on the second de-multiplexor output 352 to the larger memory system 304 to be stored. Eventually, as shown in FIG. 6C, memory read requests 316 are received that read out write data 308W for memory write requests 306 [1-8] as read data 318. Thus, as each write data 308W is read out from a memory read request 316 as read data 318, a memory entry 314(1)-314(S) of the smaller memory system 302 becomes available. In response, the memory access circuit 323 asserts the larger memory control signal 350 to cause the multiplexor circuit 344 to forward stored write data 308W in the larger memory system 304 as read data 308R for the memory write requests 306 [5, 6, 7, 8] to be stored in the smaller memory system 302. As shown in FIG. 6C, the read data 308R for each of memory write requests 306 [1-8] can be read out sequentially for each clock signal (clk) such that the read latency is the read access latency of the smaller memory system 302.

With continuing reference to FIG. 6C, by the time the ninth memory write request 306 [9] is received, the larger memory system 304 has been depleted of stored write data 308W for memory write request 306 [5-8]. Thus, the memory access circuit 323 can again write the write data 308W for memory write requests 306 [9-12] to the smaller memory system 302 before it fills up similar to how memory write request 306 [1-4] were written to the smaller memory system 302. Then, because the smaller memory system 302 is full after memory write request 306 [9-12] are received, then subsequently received memory write requests 306 [13-16] are written to the larger memory system 304 similar to how write data 308W for memory write requests 306 [5-8] were written to the larger memory system 304. Each of the write data 308W is directly stored or eventually stored in the smaller memory system 302, which can then be read out as read data 318 onto the memory read output 320.

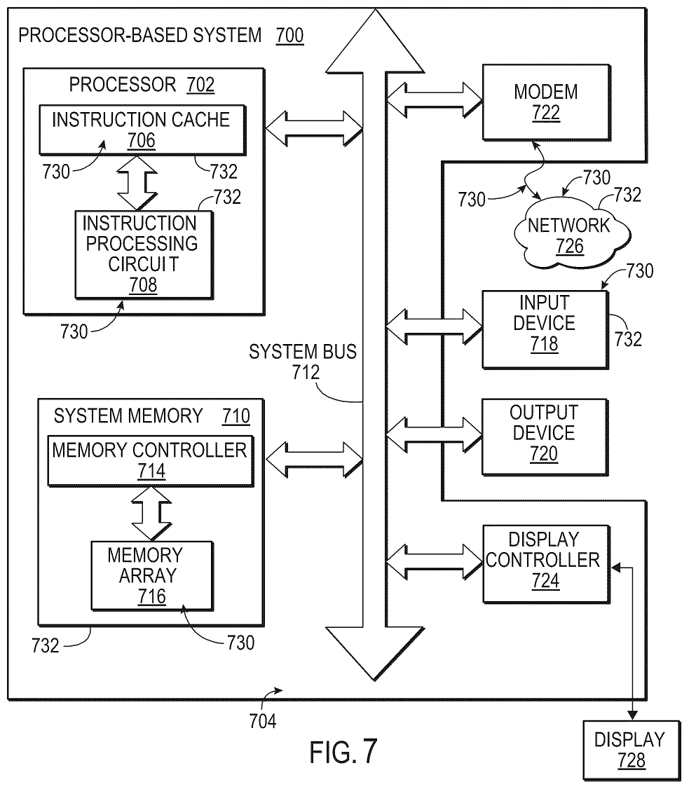

FIG. 7 is a block diagram of an exemplary processor-based system 700 that includes a processor 702 that can also include a conjoined memory system(s) 704 including, but not limited to, the conjoined memory system 300 in FIG. 3, and that can perform memory operations according to any of the memory access processes 400, 500 in FIGS. 4 and 5 as non-limiting examples. The processor-based system 700 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server or a user's computer. In this example, the processor-based system 700 includes the processor 702. The processor 702 represents one or more general-purpose processing circuits, such as a microprocessor, central processing unit, or the like. The processor 702 is configured to execute processing logic in computer instructions for performing the operations and steps discussed herein.

The processor 702 also includes an instruction cache 706 for temporary, fast access memory storage of instructions and an instruction processing circuit 708. Fetched or prefetched instructions from a memory, such as from a system memory 710 over a system bus 712, are stored in the instruction cache 706. The system bus 712 could include the conjoined memory system 704 and/or could include node circuits that each could include conjoined memory systems 704. The instruction processing circuit 708 is configured to process instructions fetched into the instruction cache 706 and process the instructions for execution. The instruction processing circuit 708 is configured to insert the fetched instructions into one or more instruction pipelines that are then processed to execution.

The processor 702 and the system memory 710 are coupled to the system bus 712 and can intercouple peripheral devices included in the processor-based system 700. As is well known, the processor 702 communicates with these other devices by exchanging address, control, and data information over the system bus 712. For example, the processor 702 can communicate bus transaction requests to a memory controller 714 in the system memory 710 as an example of a slave device. Although not illustrated in FIG. 7, multiple system buses 712 could be provided, wherein each system bus constitutes a different fabric. In this example, the memory controller 714 is configured to provide memory write requests to a memory array 716 in the system memory 710. The memory array 716 is comprised of an array of storage bit cells for storing data. The system memory 710 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 712. As illustrated in FIG. 7, these devices can include the system memory 710, one or more input device(s) 718, one or more output device(s) 720, a modem 722, and one or more display controllers 724, as examples. The input device(s) 718 can include any type of input device, including, but not limited to, input keys, switches, voice processors, etc. The output device(s) 720 can include any type of output device, including, but not limited to, audio, video, other visual indicators, etc. The modem 722 can be any device configured to allow exchange of data to and from a network 726. The network 726 can be any type of network, including, but not limited to, a wired or wireless network, a private or public network, a local area network (LAN), a wireless local area network (WLAN), a wide area network (WAN), a BLUETOOTH™ network, and the Internet. The modem 722 can be configured to support any type of communications protocol desired. The processor 702 may also be configured to access the display controller(s) 724 over the system bus 712 to control information sent to one or more displays 728. The display(s) 728 can include any type of display, including, but not limited to, a cathode ray tube (CRT), a liquid crystal display (LCD), a plasma display, etc.

The processor-based system 700 in FIG. 7 may include a set of instructions 730 that may be used to provide the functionality, including to control the operation of the conjoined memory system(s) 704. The instructions 730 may be stored in the system memory 710, processor 702, and/or instruction cache 706 as examples of non-transitory computer-readable medium 732. The instructions 730 may also reside, completely or at least partially, within the system memory 710 and/or within the processor 702 during their execution. The instructions 730 may further be transmitted or received over the network 726 via the modem 722, such that the network 726 includes the non-transitory computer-readable medium 732.

While the non-transitory computer-readable medium 732 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (RAM), a magnetic disk storage medium, an optical storage medium, flash memory devices, etc.) and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories, registers, or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium, and executed by a processor or other processing device, or combinations of both. The components of the processors and systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be referenced throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A memory system, comprising:
a smaller memory system comprising a plurality of first memory entries each configured to store data; and
a larger memory system comparing a plurality of second memory entries each configured to store data, and wherein the number of the plurality of second memory entries is larger than the number of the plurality of first memory entries;
the memory system configured to:
in response to receipt of a first memory write request comprising first write data on a memory write input:
determine if none of the plurality of first memory entries in the smaller memory system are available for data storage; and
in response to determining none of the plurality of first memory entries are available for data storage:
forward the first memory write request to the larger memory system;
the larger memory system configured to:
in response to receipt of a forwarded memory write request, write the write data from the forwarded memory write request to a second memory entry of the plurality of second memory entries; and
forward first read data stored in a next second memory entry of the plurality of second memory entries to the smaller memory system;
the smaller memory system configured to, in response to receipt of the first read data, write the first read data to a first memory entry of the plurality of first memory entries; and
the memory system further configured to:
receive a next memory read request; and
in response to the received next memory read request:
assert second read data stored in a next first memory entry of the plurality of first memory entries in the smaller memory system onto a memory read output.

2. The memory system of claim 1 further configured to, in response to determining none of the plurality of first memory entries are available for data storage;
determine if any of the plurality of second memory entries in the larger memory system are available for data storage; and
in response to determining any of the plurality of second memory entries in the larger memory system are available for data storage:
forward the first memory write request to the larger memory system.

3. The memory system of claim 1 further configured to, in response to receipt of the first memory write request comprising first write data on the memory write input;
determine if any of the plurality of first memory entries in the smaller memory system are available for data storage; and
in response to determining any of the plurality of first memory entries are available for data storage:
forward the first memory write request to the smaller memory system; and
the smaller memory system further configured to:
in response to receipt of a forwarded memory write request, write the write data from the forwarded memory write request to a first memory entry of the plurality of first memory entries available for data storage.

4. The memory system of claim 3 further configured to, in response to determining none of the plurality of first memory entries are available for data storage;
determine if a second memory entry of the plurality of second memory entries in the larger memory system is available for data storage; and
in response to determining the second memory entry of the plurality of second memory entries in the larger memory system is not available for data storage:
delay the forwarding of first memory write request.

5. The memory system of claim 1 further configured to, in response to receipt of a second memory write request comprising second write data on the memory write input;
determine if all of the plurality of second memory entries in the larger memory system are available for data storage; and
in response to determining all of the plurality of second memory entries in the larger memory system are not available for data storage:
forward the second memory write request to the larger memory system.

6. The memory system of claim 1 further configured to, in response to receipt of a second memory write request comprising second write data on the memory write input;
determine if all of the plurality of second memory entries in the larger memory system are available for data storage; and
in response to determining all of the plurality of second memory entries in the larger memory system are available for data storage:
forward the second memory write request to the smaller memory system.

7. The memory system of claim 1 further configured to:
determine if any of the plurality of first memory entries in the smaller memory system are available for data storage; and
the larger memory system is configured to:
forward the first read data stored in the next second memory entry of the plurality of second memory entries to the smaller memory system, in response any of the plurality of first memory entries in the smaller memory system being available for data storage.

8. The memory system of claim 1, wherein the larger memory system is configured to forward the first read data stored in the next second memory entry of the plurality of second memory entries to the smaller memory system, in response to the next memory read request.

9. The memory system of claim 1, further comprising a de-multiplexor circuit, comprising:
a de-multiplexor input coupled to the memory write input;
a first de-multiplexor output coupled to the smaller memory system;
a second de-multiplexor output coupled to the larger memory system; and
a de-multiplexor control input;
the memory system further configured to, in response to determining none of the plurality of first memory entries are available for data storage:
assert a larger memory control signal on the de-multiplexor control input to cause the de-multiplexor circuit to assert the first memory write request on the second de-multiplexor output to be forwarded to the larger memory system.

10. The memory system of claim 9 further configured to:
in response to receipt of the first memory write request comprising first write data on the memory write input:
determine if any of the plurality of first memory entries in the smaller memory system are available for data storage; and
in response to determining any of the plurality of first memory entries are available for data storage:
forward the first memory write request to the smaller memory system; and
the smaller memory system further configured to:
in response to receipt of a forwarded memory write request, write the write data from the forwarded memory write request to the first memory entry of the plurality of first memory entries; and
the memory system further configured to, in response to determining the first memory entry of the plurality of first memory entries is available for data storage:
assert a smaller memory control signal on the de-multiplexor control input to cause the de-multiplexor circuit to assert the first memory write request on the first de-multiplexor output to be forwarded to the smaller memory system.

11. The memory system of claim 10, further comprising a multiplexor circuit, comprising:
a first multiplexor input coupled to the first de-multiplexor output;
a second multiplexor input coupled to the larger memory system;
a multiplexor output coupled to the smaller memory system; and
a multiplexor control input;
wherein:
the larger memory system is configured to forward the first read data on the second multiplexor input; and
the memory system further configured to, in response to determining none of the plurality of first memory entries are available for data storage:
assert the larger memory control signal on the multiplexor control input to cause the multiplexor circuit to assert the first read data on the second multiplexor input on the multiplexor output to be forwarded to the smaller memory system.

12. The memory system of claim 11 further configured to, in response to determining the first memory entry of the plurality of first memory entries is available for data storage:
assert the smaller memory control signal on the multiplexor control input to cause the multiplexor circuit to assert the first memory write request on the first multiplexor input on the multiplexor output to be forwarded to the smaller memory system.

13. The memory system of claim 3, further comprising:
a smaller memory tracker circuit coupled to the smaller memory system, the smaller memory tracker circuit configured to:
track the availability of the plurality of first memory entries in the smaller memory system; and
generate a smaller memory tracker indicator indicating the availability of at least one first memory entry of the plurality of first memory entries in the smaller memory system; and
a larger memory tracker circuit coupled to the larger memory system, the larger memory tracker circuit configured to:
track the availability of the plurality of second memory entries in the larger memory system; and
generate a larger memory tracker indicator indicating the availability of the plurality of second memory entries in the larger memory system;
the memory system configured to:
determine if none of the plurality of first memory entries in the smaller memory system are available for data storage based on the larger memory tracker indicator indicating the availability of the plurality of second memory entries in the larger memory system; and
determine if any of the plurality of first memory entries in the smaller memory system are available for data storage based on the smaller memory tracker indicator indicating the availability of the first memory entry in the smaller memory system for data storage.

14. The memory system of claim 1, wherein:
the smaller memory system comprises a smaller random access memory (RAM) comprising the plurality of first memory entries comprising a plurality of first RAM entries; and
the larger memory system comprises a larger RAM comprising the plurality of second memory entries comprising a plurality of second RAM entries.

15. The memory system of claim 1, wherein:
the smaller memory system comprises a smaller flop memory comprising the plurality of first memory entries comprising a plurality of first flip flops serially coupled to each other; and
the larger memory system comprises a larger flop memory comprising the plurality of second memory entries comprising a plurality of second flip flops serially coupled to each other.

16. A method of performing data accesses to a memory system comprising a smaller memory system comprising a plurality of first memory entries each configured to store data, and a larger memory system comparing a plurality of second memory entries each configured to store data, and wherein the number of the plurality of second memory entries is larger than the number of the plurality of first memory entries, the method comprising:
receiving a first memory write request comprising first write data on a memory write input;
determining if none of the plurality of first memory entries in the smaller memory system are available for data storage, in response to receiving the first memory write request;
forwarding the first memory write request to the larger memory system, in response to determining none of the plurality of first memory entries in the smaller memory system are available for data storage;
writing, in a second memory entry of the plurality of second memory entries in the larger memory system, the first write data from the forwarded memory write request, in response to receipt of the forwarded memory write request to the larger memory system;
forwarding first read data stored in a next second memory entry of the plurality of second memory entries in the larger memory system, to the smaller memory system;
writing, in a first memory entry of the plurality of first memory entries in the smaller memory system, the first read data, in response to receipt of the first read data;
receiving a next memory read request; and
asserting second read data stored in a next first memory entry of the plurality of first memory entries in the smaller memory system onto a memory read output, in response to the received next memory read request.

17. The method of claim 16 further comprising, in response to receipt of the first memory write request comprising first write data on the memory write input:
determining if any of the plurality of first memory entries in the smaller memory system are available for data storage;
forwarding the first memory write request to the smaller memory system, in response to determining any of the plurality of first memory entries being available for data storage; and
writing, in the smaller memory system, the first write data from the forwarded memory write request to the first memory entry of the plurality of first memory entries.

18. The method of claim 16 further comprising, in response to receipt of a second memory write request comprising second write data on the memory write input;
determining if all of the plurality of second memory entries in the larger memory system are available for data storage; and
forwarding the second memory write request to the larger memory system, in response to determining all of the plurality of second memory entries in the larger memory system are not available for data storage.

19. The method of claim 16 further comprising, in response to receipt of a second memory write request comprising second write data on the memory write input;
determining if all of the plurality of second memory entries in the larger memory system are available for data storage; and
forwarding the second memory write request to the smaller memory system, in response to determining all of the plurality of second memory entries in the larger memory system are available for data storage.

20. A non-transitory computer-readable medium having stored thereon computer executable instructions which, when executed by a processor, cause the processor to access a memory system comprising a smaller memory system comprising a plurality of first memory entries each configured to store data, and a larger memory system comparing a plurality of second memory entries each configured to store data, and wherein the number of the plurality of second memory entries is larger than the number of the plurality of first memory entries, by causing the processor to:
receive a first memory write request comprising first write data on a memory write input;
determine if none of the plurality of first memory entries in the smaller memory system are available for data storage, in response to receiving the first memory write request;
forward the first memory write request to the larger memory system, in response to determining none of the plurality of first memory entries in the smaller memory system are available for data storage;
write, in a second memory entry of the plurality of second memory entries in the larger memory system, the first write data from the forwarded memory write request, in response to receipt of the forwarded memory write request to the larger memory system;
forward first read data stored in a next second memory entry of the plurality second memory entries in the larger memory system, to the smaller memory system;
write, in a first memory entry of the plurality of first memory entries in the smaller memory system, the first read data, in response to receipt of the first read data;
receive a next memory read request; and
assert second read data stored in a next first memory entry of the plurality of first memory entries in the smaller memory system onto a memory read output, in response to the received next memory read request.
